(19) United States
(12) Patent Application Publication
(10) Pub. No.: US 2010/0127030 A1
(43) Pub. Date: May 27, 2010

(54) Coupling device for attaching an accessory or a luggage holding unit in the front region of a bicycle

(76) Inventor: Alois Mühlberger, Koln (DE)

Correspondence Address: PAULEY PETERSEN & ERICKSON, 2800 WEST HIGGINS ROAD, SUITE 365, HOFFMAN ESTATES, IL, 60169, US

(21) Appl. No.: 12/309,284

(22) PCT Filed: Jul. 12, 2007
(86) PCT No.: PCT/EP2007/006182

§ 371 Date: Dec. 7, 2009

(30) Foreign Application Priority Data
Jul. 13, 2006 (DE) 202006010789.4
Jul. 14, 2006 (DE) 202006020083.5
Apr. 25, 2007 (DE) 202007005942.6

(51) Int. Cl. B62J 11/00

(52) U.S. Cl. 224/420; 224/448

(57) ABSTRACT

The invention relates to a coupling device for attaching an accessory, such as a cycling computer, navigation device, light, radio, music player, map holder or a luggage holding unit in the front region of a bicycle, to a holding section (70, 71, 72, 80), which is supported on the front part of the handlebars (1), for attachment of the accessory or the luggage holding unit. A compact construction having simple, stable installation is obtained in that the holding section (70, 71, 72, 80) is designed for tool-free attachment of the accessory or of the luggage holding unit and is integrated directly in the front part of the handlebars (1) or in the clamping clip (11) of the front part of the handlebars (1).

### BACKGROUND OF THE INVENTION

1. Field of the Invention

This invention relates to a coupling device for attaching an accessory, such as a trip computer, a navigation device, a light, a radio, a music player, a map holder, or a luggage holding unit in the front region of a bicycle, to a mounting section, which is supported on the handlebar stem, for attachment of the accessory or luggage holding unit.

2. Discussion of Related Art

European Patent Reference EP 1 065 140 A2 discloses a coupling device with a mounting section situated on the top of a handlebar clamping bracket that clamps the handlebar to the projecting part of the handlebar stem. In this instance, an accessory in the form of a display unit can be oriented on the mounting section in various directions in relation to a longitudinal direction of the bicycle and is then clamped by a screw in a threaded opening on the handlebar clamping bracket. For insertion of the screw, a cavity is in the housing of the display unit, into which the screw is inserted and must then be tightened in the threaded bore, which is not easily accomplished.

Various other coupling devices for accessories or luggage holding units are disclosed in U.S. Pat. No. 2,253,649 A, Japanese Patent Reference JP 2005-26 29 80 A, French Patent Reference FR 1,056,124 A, PCT International Application WO 2005/047091 A1, and French Patent Reference FR 1,017,327 A. In these, too, various individual parts for coupling are provided, which likewise involve a corresponding degree of complexity.

European Patent Reference EP 0 477 010 A1 discloses another coupling device. In this known coupling device, a luggage holding unit is coupled to a pivoting coupling part that is fastened by brackets to the handlebars of a bicycle, lateral to a connecting point between the handlebars and the handlebar stem, so that it can be moved into various pivoting positions. On the coupling part, in addition to the brackets, there are toothed sections that are brought into engagement with a respective set of teeth on a T-shaped additional part of the coupling device, which is in the form of a half-shell and is placed against the tube of the handlebars, and with the upright of the T-shaped part, which is likewise embodied in the form of a half-shell, is attached by another bracket to the projecting part of the handlebar stem. The support piece attached to the handlebar stem serves as a retaining arm preventing a pivoting of the front coupling piece with the coupled luggage holding unit around an axis transverse to the vertical longitudinal plane of the bicycle, particularly toward the front, while the support on the handlebar prevents a rotation of the luggage holding unit around an axis extending in the longitudinal direction of the bicycle.

In a coupling device that functions in a similar fashion disclosed in German Patent Reference DE 40 08 211 A1, in which a coupling part is likewise fastened to the handlebars on both sides of the handlebar lug, a support is carried out underneath the projecting part of the handlebar stem, particularly by an adjustable control cable.

In other coupling devices for attaching a luggage holding unit to the front region of a bicycle, a coupling is carried out on handlebars, on both sides of the handlebar lug, as disclosed in PCT International Publication WO 94/11233 and German Patent Reference DE 195 34 204 C2. Here, too, attaching mechanisms and support points are provided that are similar to those in the references mentioned above.

### SUMMARY OF THE INVENTION

One object of this invention is to provide a coupling device of the type mentioned above but with a compact design, which permits a simple attachment of an accessory or luggage holding unit to the front region of a bicycle.

This object is attained with the defining characteristics taught in this specification and in the claims. In this instance, the mounting section is embodied for tool-free attachment of the accessory or luggage holding unit and is integrated directly into the handlebar stem or the handlebar clamping bracket of the handlebar stem.

The attachment to the structurally stable handlebar stem or handlebar clamping bracket produces a compact, stable design without unnecessary parts and the tool-free attachment makes it easy to install.

The manufacture and installation are achieved without additional parts because the mounting section is formed onto the handlebar stem or the handlebar clamping bracket.

Providing the mounting section with a detent engagement section for engagement with a detent element situated on the accessory or luggage holding unit to produce a detachable detent connection achieves a reliable attachment of the accessory or luggage holding unit, and they can be removed manually through simple detachment of the detent connection and can be coupled with no trouble.

The achievement of a simple, stable coupling is assisted if the mounting section has an insertion rail with two parallel guide sections, which either protrude or are embodied as recesses, or by the fact that the guide sections extend at an acute angle with respect to each other. When the guide sections are oriented at an acute angle with respect to each other, the insertion occurs from the open side of the angle so that an automatic limitation of the insertion movement of a counterpart mounting section embodied on the accessory or luggage holding unit is provided by the guide sections themselves. In addition, there can be a separate stop, which is provided particularly in the case of parallel guide sections. In this instance, the limitation of the insertion movement can be achieved by the detent connection.

Other advantageous measures include providing an accessory or luggage holding unit with a counterpart mounting section that matches the mounting section. In this instance, the counterpart mounting section can be embodied as a separate component that is mounted onto the accessory or luggage holding unit or that can be attached to it from the outset during manufacture.

Various other advantageous design embodiments are of the mounting section and counterpart mounting section so that they are able to engage with each other in a hanging, sliding, or plugging fashion and for providing a securing element for securing the accessory or luggage holding unit in the coupled state. In this instance, the securing element can, for example, be composed of the detent connection or can be composed of an optional additional locking device that secures the attached position, such as by a lock that can be released with a key element. When the detent connection is produced, the lock can, for example, prevent the detent connection from disengaging and can be released by the user in order to detach it.

Various possible positions of the accessory or luggage holding unit are achieved by situating the mounting section on the top, the front, or the underside of the handlebar stem or handlebar clamping bracket with regard to the orientation of the bicycle. In this instance, it is also possible to combine several mounting sections, which are situated in different places, with one another so that it is possible to simultaneously attach a plurality of accessories and/or luggage holding units, such as a map case or a holding box.

### BRIEF DESCRIPTION OF THE DRAWINGS

This invention is explained in view of exemplary embodiments with reference to the drawings, wherein:

FIG. 1A is a perspective view of a coupling unit of a coupling device with a coupling piece in the pivoted-out position;

FIG. 1B is a perspective view of a modification of the coupling unit shown in FIG. 1A, with the coupling piece in the pivoted-in position and an adjusting element for adjusting its pivoting range;

FIG. 1C is a perspective view of the coupling unit according to FIG. 1A, with the coupling piece in the pivoted-in position, when mounted onto the handlebar stem;

FIG. 2 is a side view of a coupling unit with a clamping section, which corresponds to the coupling unit of FIG. 1A, and an intermediate piece connected to the coupling piece and securing element by a hinge element;

FIG. 3 is a side view of another embodiment of a coupling device with a coupling unit, which is mounted to the handlebar stem and which has an additional support;

FIG. 4 shows the coupling device according to FIG. 3, with a luggage holding unit coupled to it;

FIGS. 5A through 5C each shows another embodiment of a coupling unit, which is coupled to the handlebar stem and which has a modified coupling piece, in a side view, a top view, and an individual side view of the coupling piece;

FIG. 6A is a perspective view of another embodiment for a coupling unit;

FIG. 6B is a side view of the coupling unit of FIG. 6A and a coupling piece that can be mounted onto it;

FIG. 6C is a perspective view of the coupling piece shown in FIG. 6B;

FIG. 7A shows another embodiment of a coupling device provided on a coupling unit;

FIG. 7B shows various mounting sections on the handlebar stem or a handlebar clamping bracket;

FIG. 7C shows another embodiment of a coupling unit that can be mounted onto the handlebar stem;

FIG. 7D is a side view of a luggage holding unit in the form of a bicycle basket, with a counterpart mounting section that can be attached to the mounting section;

FIG. 7E is a rear view of the counterpart mounting section;

FIG. 8A is a cross-sectional view of another exemplary embodiment for a mounting section that is or can be mounted onto the handlebar stem or the handlebar clamping bracket;

FIG. 8B is a cross-sectional view of a counterpart mounting section;

FIG. 8C is a perspective view of the mounting section according to FIG. 8A;

FIG. 8D is a top view of the counterpart mounting section of FIG. 8B;

FIG. 9A shows a handlebar stem with a mounted handlebar clamping bracket with several mounting sections;

FIG. 9B shows another embodiment for a handlebar stem with a handlebar clamping bracket and several mounting sections;

FIG. 10A shows a perspective view of another embodiment for a handlebar stem with a handlebar clamping bracket and several mounting sections;

FIG. 10B shows a handlebar stem with a handlebar clamping bracket and a luggage holding unit mounted onto a mounting section;

FIG. 10C shows a handlebar stem with a handlebar clamping bracket and an accessory mounted onto a mounting section as well as a luggage holding unit mounted onto a mounting section;

FIG. 11A shows another exemplary embodiment for a handlebar stem with a removed handlebar clamping bracket that has a mounting section provided on it;

FIG. 11B shows a counterpart mounting section that can be fastened to an accessory or luggage holding unit and is adapted to the mounting section according to FIG. 11A;

FIG. 11C shows a handlebar clamping bracket with a different embodiment of a mounting section; and

FIG. 11D is a different perspective view of the counterpart mounting section according to FIG. 11B.

### DETAILED DESCRIPTION OF THE INVENTION

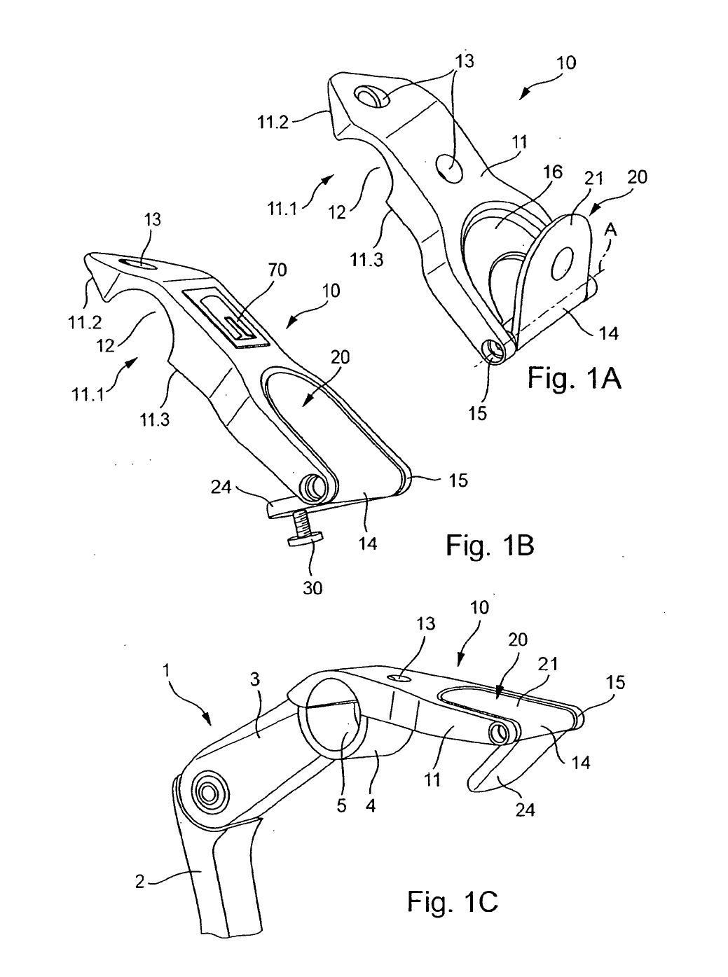

FIG. 1A shows a coupling unit 10 with a connecting element 11 in the form of a handlebar clamping bracket and a tongue-shaped coupling piece 20, which can be pivoted in and out, attached to it in a hinged fashion by a hinge 15. As clear from FIG. 1C, in its one end region, the connecting element 11 has a clamping section 11.1 that can be attached to a handlebar stem 1 and has a mounting section 12 for fitting over a tube section of the handlebars (not shown) of a bicycle. The mounting section 12, which in this instance is approximately semicircular in cross section and extends in the axial direction, such as over several centimeters of the tube section of the handlebars, completes a handlebar receptacle 5 on the top of a forward-projecting part 3 of the handlebar stem 1 near or in the vicinity of which a clamping device 4 is provided. The handlebar receptacle 5 is likewise approximately semicircular in cross section and extends in the axial direction, such as over several centimeters of the tube section of the handlebars. The projecting part 3 of the handlebar stem 1 can be fixed in relation to a column 2 or can be set to various angles. The mounting section 12 is adjoined at the front and back in the longitudinal direction of the bicycle and at the front and back in the circumference direction by respective extensions 11.2, 11.3 of the connecting element 11 that have respective fastening bores 13, which, when the connecting element 11 is placed onto the handlebar stem 1 in the correct position line up with bores provided in front of and behind the handlebar receptacle 5 so that the connecting element 11, while accommodating the handlebars, can be solidly clamped by clamping elements 17 in the form of connecting screws (see FIG. 3). In this instance, the extensions 11.2, 11.3 of the clamping section 11.1 rest flat against correspondingly embodied counterpart surfaces in front of and behind the handlebar receptacle 5 near or in the region of the clamping device 4 of the handlebar stem 1 so that they produce a stable support of the connecting element 11 on the handlebar stem 1, thus providing a stable support against a rotation both around a horizontal axis transverse to the vertical longitudinal plane of the bicycle and around an axis extending in the longitudinal direction of the bicycle. The seating of the connecting element 11 on the handlebar stem 1 thus obtained provides a simple, clear-cut installation. The connecting element 11 can thus replace the manufacturer's clamping part provided on the handlebar stem 1 for clamping the handlebars.

In a support section 14, the coupling piece 20, which has an adaptor piece for coupling a luggage holding unit 60 such as a luggage rack (see FIG. 4), is attached in pivoting fashion by the hinge 15 to the front region of the connecting element 11 remote from the clamping region 11.1 and can be pivoted out by an adjustable pivot angle to couple the luggage holding unit 60. The pivot angle can be adjusted so that the luggage holding unit 60 is solidly supported in a desired position, for example in the case of a basket, so that the opening is oriented upward. In the uncoupled state of a luggage holding unit 60, the coupling piece 20 can be pivoted into a recess 16 adapted to it that is provided in the connecting element 11. A snap connection is advantageous for a simple fastening. In this instance, the coupling piece 20 forms a pivoting lever, which is situated in the region of the top of the connecting element 11 and is rigidly connected on the other side of the hinge 15 to a lower pivoting lever, which is supported as a support section 24 in the lower region of the connecting element 11 when the coupling piece 20 is in the pivoted-out position. In one embodiment, an adjustable adjusting element 30 is provided for supporting it and makes it possible to vary the pivot angle of the coupling piece 20 or its coupling section 21. For example, the adjusting element 30 is embodied in the form of a screw that can be screwed a greater or a lesser distance into the lower pivot lever. The coupling piece 20 pivots in the hinge 15 around a hinge axis A.

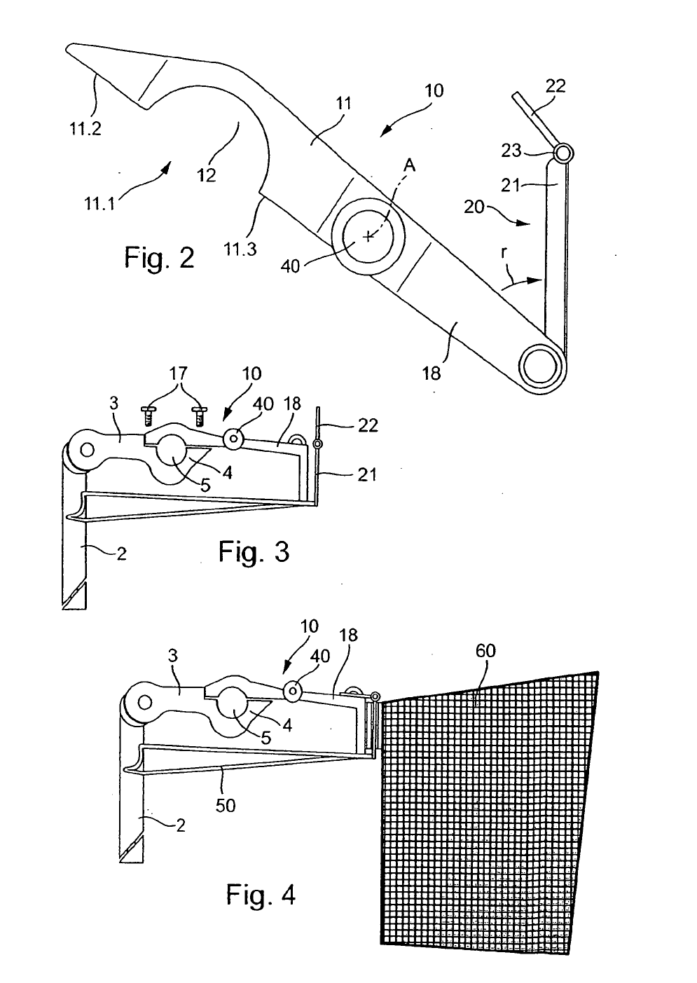

As FIG. 2 shows, the coupling piece 21 can be connected to the connecting element 11 by a hinge element 40 and an intermediate piece 18, permitting additional pivotability of the coupling piece 20 and the coupling section 21. A selected pivot angle can be locked in place by a locking mechanism, which for example has reciprocally engaging, disengageable teeth on the connecting element 11 on the one hand and on the intermediate piece 18 or another intermediate element on the other. In this instance, the teeth can either be provided on the connecting element 11 and the intermediate piece 18 on both sides in a plane parallel to the vertical longitudinal plane, or can be provided on a cylindrical inner wall on the one hand and on a cylindrical outer wall on the other. Other locking mechanisms are also conceivable. Similar locking mechanisms can also be provided near or in the region of the hinge 15.

A similar coupling unit, as shown in FIG. 2, is also shown in the schematic representations according to FIGS. 3 and 4. Here, a connecting element 11 provided on the coupling unit 10 is fastened to the handlebar stem 1 near or in the region of the clamping device 4, as described above. In the exemplary embodiments according to FIGS. 3 and 4, the coupling section is mounted to an initially downward-oriented section at the front end region of the intermediate piece 18 and likewise has an upward-protruding adapter piece, which is attached by a short forward-pointing strut and on which the luggage holding unit 60 can be suspended with an adapted counterpart adapter element. In order to secure the coupling of the luggage holding unit 60, the coupling section 21 has a securing element 22 (also see FIG. 2) that can be folded over and locked in position, such as embodied as a lockable pivoting lever, after having been guided through the counterpart adaptor element on the luggage holding unit 60. There are also other possible locking devices, such as a detachable detent connection or snap element, for securing the coupling. It is also possible to provide a locking mechanism or stopping device equipped with a key. In this instance, the securing element 22 is mounted to the upper edge of the coupling section 21 by a hinge element 23. In order to securely support the luggage holding unit 60 even when it is heavily loaded, it is also possible to provide a support 50 that rests against the column 2 of the handlebar stem 1, as shown in FIG. 4. The lever force in the pivoting direction r (see FIG. 2) produced by the load on the luggage holding unit 60 is braced by the support section 24, which corresponds to the support section 24 according to FIG. 1, possibly with the additional action of the support 50.

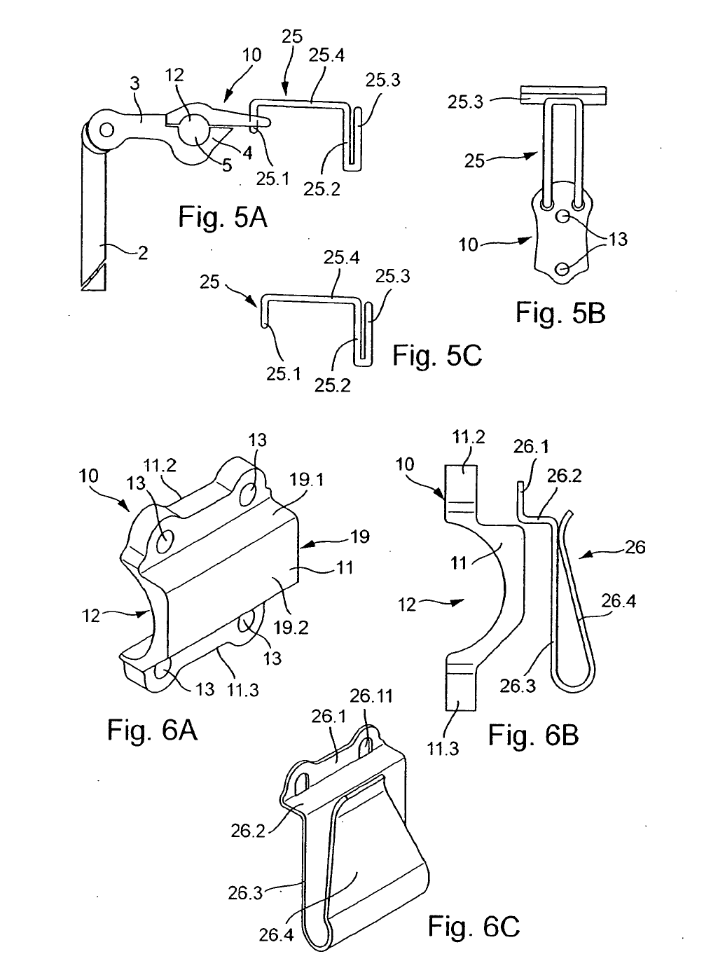

FIGS. 5A, 5B, and 5C show another coupling piece 25. In this instance, a connecting piece 25.1 is suspended in non-rotating fashion in bores in the connecting element 11 of the coupling unit 10 and transitions via a forward-extending intermediate part 25.4, a downward-pointing coupling section 25.2, and a short forward-pointing section into the hook-shaped, upward-oriented coupling section 25.3 to permit the resulting adapter piece to accommodate the counterpart adaptor, which is adapted to it, on the luggage holding unit 60.

FIGS. 6A, 6B, and 6C show yet another coupling piece 26. In this instance, the coupling unit 10 has a connecting element with a mounting section 12 that is adapted to the tubular section of the handlebars as well as extensions 11.2, 11.3 adjoining it at the front and back in the circumference direction, which are adapted to the clamping device 4 of the handlebar stem 1 and provided with corresponding aligned fastening bores 13. In this instance, for example two fastening bores are provided in each of the two extensions 11.2, 11.3 as long as corresponding bores are also provided in the clamping device 4 of a corresponding handlebar stem 1. In this handlebar stem 1, the handlebar receptacle 5 is shown, for example, with its opening at the front so that the coupling piece 26 is mounted from the front, set into place in flange fashion against the extensions 11.2, 11.3, and clamped to them with the fastening screws. The coupling piece 26 is formed as a simple element and protrudes only slightly forward, making a steering movement only slightly more difficult, even with a heavily loaded luggage holding unit 60. In order to couple the luggage holding unit 60, the coupling piece 26 can be attached to the front of the coupling unit 10 by the clamping element 17 or clamping screws situated at the top in the drawing; the coupling piece 26 also has a hook-shaped adapter part for attachment of an adapted counterpart adapter of the luggage holding unit 60. As shown in the drawing, the coupling piece 26 has a flange-like connecting section 26.1 in which two openings 26.11 are provided, such as in the form of oblong holes, with the same hole pattern as the fastening bores 13 in the upper extension 11.2. On the top of the forward-projecting section of the coupling unit 10 or connecting element, a flat, forward-extending section is provided, on which a correspondingly adapted support section 26.2 of the coupling piece 26 rests in the mounted state. An intermediate section 26.3 of the coupling piece 26 rests flat against the vertically downward-extending front of the connecting element and transitions via an arc-shaped section into the upward-pointing, hook-shaped coupling section 26.4. The coupling piece is secured in the counterpart adapter by the coupling section 26.4 being supported in a resilient fashion by the lower arc-shaped part and with its upper free end, rests resiliently against the front of the intermediate section 26.3.

Various other embodiments of the coupling unit 10 for connecting exclusively to the handlebar stem 1 are possible. The handlebar stem 1 can have a connecting section on its upper, frontal, or lower outside, to which the connecting element 11 of the coupling unit 10 can be solidly attached by connecting elements adapted to the connecting section. The connecting sections can be embodied as sliders or flat sections equipped with a screw connection, a snap connection, or a detent connection. In addition, the coupling unit 10 can have an additional mounting section 70 (see FIG. 1B) in order to attach another accessory to it, such as a measuring device, a navigation device, an odometer, or a holding case.

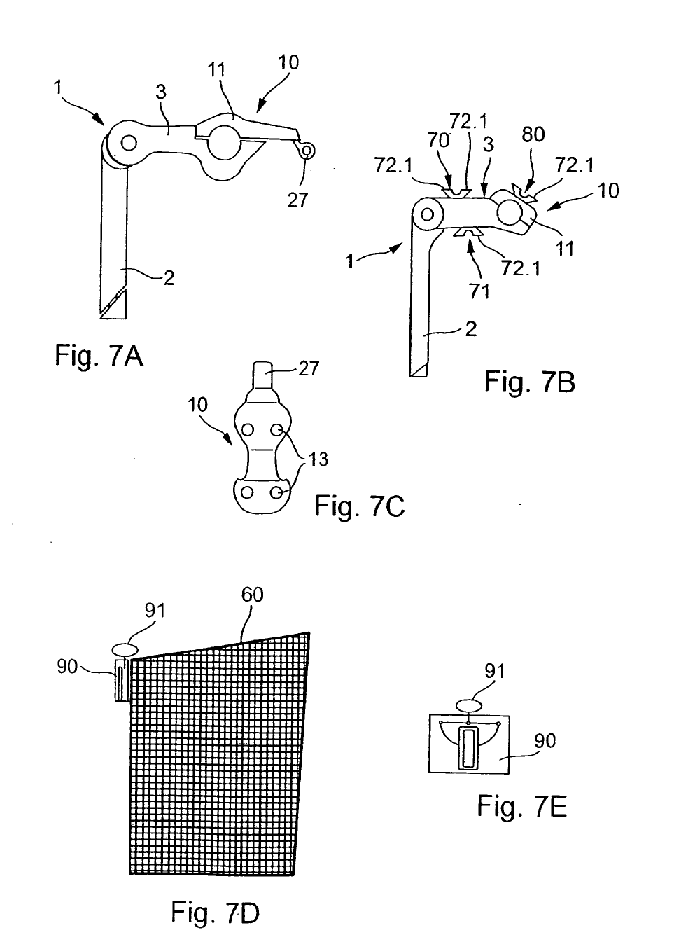

FIG. 7A shows another exemplary embodiment for a handlebar stem 1, with a column 2 and a projecting part 3 connected to it, to which is mounted a connecting element 11 for clamping the handlebars and simultaneously for coupling a luggage holding unit by a coupling section 27. The connecting element 11, which simultaneously forms a handlebar clamping bracket, is embodied, for example, as shown in the top view in FIG. 7C and is solidly clamped to the projecting part 3 by four fastening bores 13 arranged in a plane.

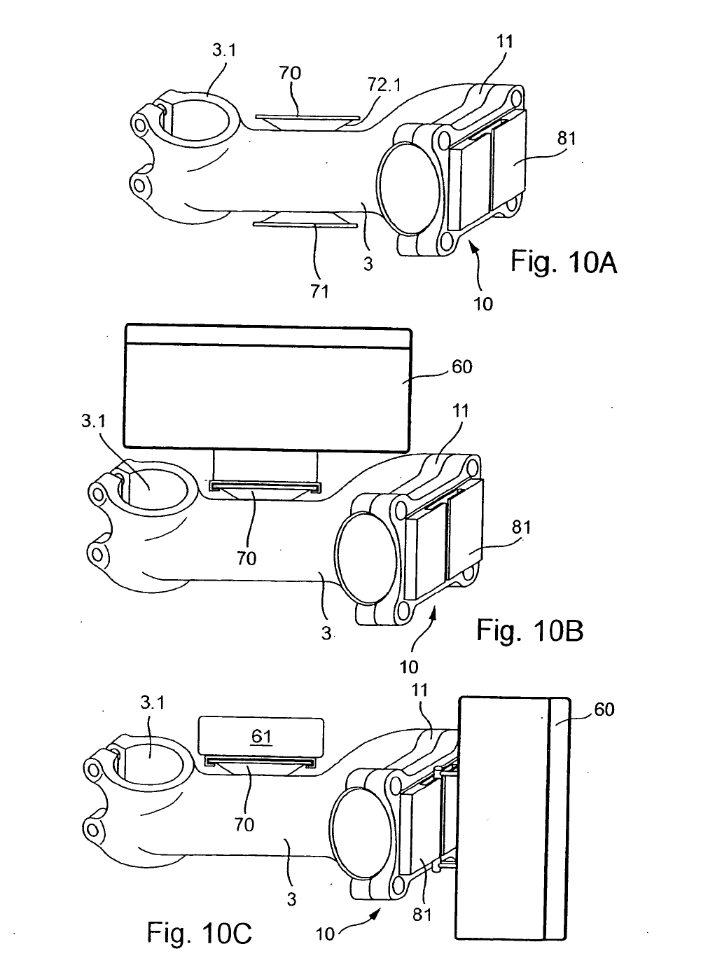

FIG. 7B shows another exemplary embodiment for a handlebar stem 1, the top and bottom of whose projecting part 3 each has a mounting section 70 and 71, respectively, for example already formed into them during manufacture. The two mounting sections 70, 71 are protruding and each has respective guide sections 72.1 into which it is possible to slide complementarily embodied counterpart guide sections of a counterpart mounting section provided on an accessory 61 (see FIG. 10C) such as a trip computer, a navigation device, a light, a radio, a music player, or a map holder, or provided on a luggage holding unit 60. FIG. 7B also shows a mounting section 80 that is attached to the connecting element 11, which is formed as a handlebar clamping bracket, and can be embodied in accordance with the mounting sections 70, 71. Such a handlebar clamping bracket, for example with a mounting section 80 formed onto it, can simply be used as a replacement part for a conventional handlebar clamping bracket.

FIG. 7D shows a counterpart mounting section 90, which is situated on the back side, relative to the direction of travel, of a luggage holding unit 60 in the form of a basket, and which is embodied, for example, for insertion into a mounting section. In this instance, the mounting section is situated on the front of the connecting element 11 in the form of the handlebar clamping bracket. In order to secure the coupled connection here, a securing mechanism is advantageously provided, for example a detent connection or a locking mechanism, which can be manually released by a schematically depicted actuating element 91 in order to detach the coupled connection.

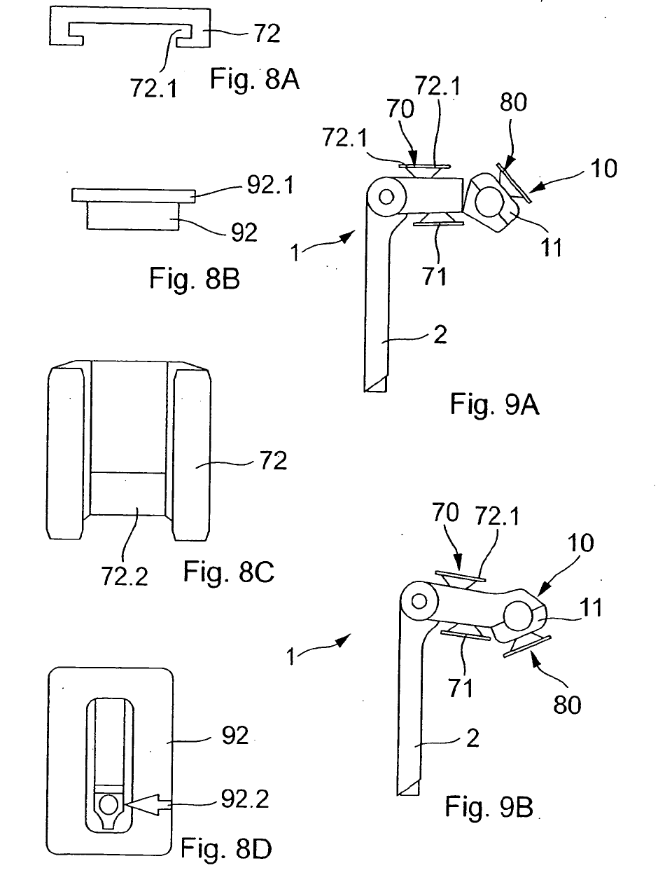

FIGS. 8A, 8B, 8C, and 8D show another mounting section that can be attached to or is formed onto the projecting part 3 of the handlebar stem 1 or the handlebar clamping bracket. The mounting section 72 has lateral groove-like guide sections 72.1, which extend parallel to each other and are situated in the same plane so that when viewed together, they form a sort of T-groove. As shown in a perspective view in FIG. 8C, the base wall that connects the two guide sections 72.1 to each other has a protruding or recessed detent section 72.2 integrated into it, which is equipped with a detent shoulder. A counterpart mounting section 92 shown in FIGS. 8B and 8D is adapted to the mounting section 72 and is inserted with its lateral, parallel edge sections as counterpart guide sections 92.1 into the groove-like guide sections 72.1 while a detent element 92.2 comprised of a slot with a resilient detent tab and a detent shoulder is embodied so that it snaps into the detent section 72.2 when the counterpart mounting section 92 is slid all the way into the mounting section 72. If the detent shoulder and the detent section 72.2 have detent shoulders that are steeply sloped in the direction opposite from the insertion direction, then the detent connection cannot detach by itself, but must be released, and thus the detent tab can be manually lifted up or pressed down in opposition to the spring force. The counterpart guide sections 92.1 situated on the edge of the counterpart mounting section 92 and cooperating with the guide sections 72.1 produce a clear-cut guidance with a reliable seating. In a reverse embodiment, the mounting section can have lateral edge sections that correspond to the protruding counterpart guide section, while the counterpart mounting section can instead have groove-like guide sections. It is also possible to reverse the positions of the detent section and the counterpart detent section on the mounting section and the counterpart mounting section.

FIGS. 9A and 9B show additional exemplary embodiments for handlebar stems with a projecting part and mounting sections 70, 71 mounted or formed onto it and with a mounting section 80 mounted, in particular formed, onto the handlebar clamping bracket 11. As shown in FIG. 9A, the handlebar clamping bracket is situated in the upper region of the projecting part 3 and according to FIG. 9B, it is suited in the lower region of it.

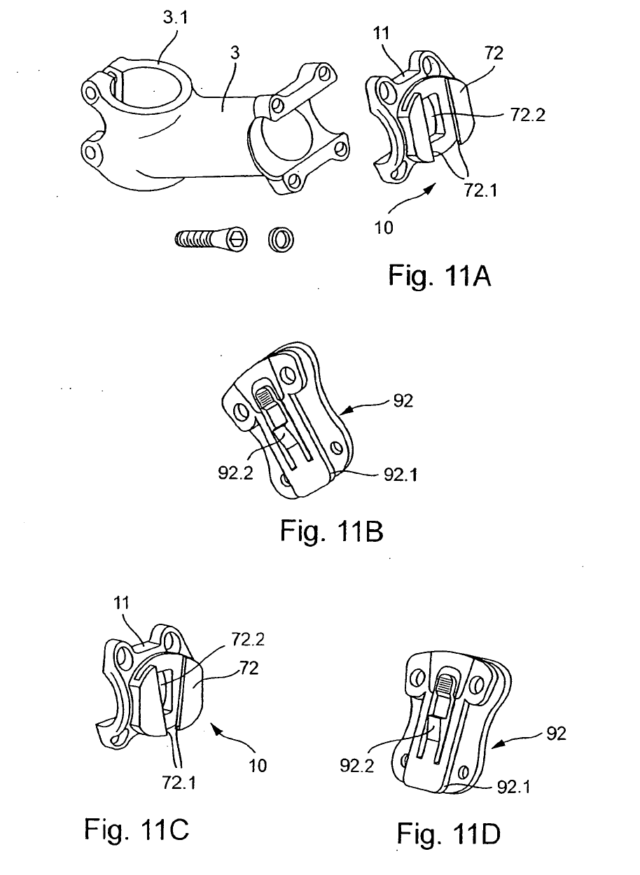

FIGS. 10A, 10B, and 10C show another exemplary embodiment of a projecting part 3 of a handlebar stem, with a connecting section 3.1 that attaches the projecting part 3 to the column and with mounting sections 70 and 71 that are situated on the top and bottom of the projecting part 3. A mounting section 81 is embodied on, in particular formed onto, the handlebar clamping bracket 11 and is embodied, for example, in a fashion similar to that shown in FIGS. 8A and 8C, namely with a T-shaped groove into which a complementarily embodied counterpart mounting section on the luggage holding unit 60 can be inserted. FIGS. 11A, 11B, 11C, and 11D show other embodiments of mounting sections 72 and counterpart mounting sections 92. In this instance, the mounting sections are mounted or formed onto the front of a connecting element in the form of a handlebar clamping bracket 11 mounted onto the front of the projecting part 3. The mounting section 70, which has groove-like guide sections 72.1, also has detent sections 72.2. The guide sections 72.1 can extend parallel to each other, as shown in FIG. 11A, or can extend at an acute angle in relation to each other, as shown in FIG. 11C. The complementary counterpart mounting section 92 with its counterpart guide sections 92.1 is then embodied in a corresponding fashion. In this instance, the counterpart mounting section 92 can be mounted to the accessory 61 or the luggage holding unit 60 during the manufacture of the latter or can be fastened to it subsequently as a separate part. The mounting section 72 and the counterpart mounting section 92 form a stable coupling unit in the form of an insertion rail and an insertion part, with the coupled position being secured by the detent mechanism. Alternatively or in addition to the detent mechanism, a locking mechanism can be provided to secure the coupled connection, such as by a locking element that can be released using a key.

The above-described integration of the mounting section into the projecting part 3 and/or the handlebar clamping bracket 11 produces a stable, compact embodiment with an easy-to-operate coupling of an accessory 61 or luggage holding unit 60 solely to the flat mounting section.

1. A coupling device for attaching an accessory (61) including a trip computer, a navigation device, a light, a radio, a music player, a map holder, or a luggage holding unit (60) in a front region of a bicycle, to a mounting section (70, 71, 72, 80, 81) which is supported on the handlebar stem (1) and is for attaching the accessory (61) or the luggage holding unit (60), the coupling device comprising:
the mounting section (70, 71, 72, 80, 81) embodied for tool-free attachment of the accessory (61) or the luggage holding unit (60) and integrated directly into the handlebar stem (1) or the handlebar clamping bracket (11) of the handlebar stem (1).

2. The coupling device according to claim 1, wherein the mounting section (70, 71, 72, 80, 81) is formed onto the handlebar stem (1) or the handlebar clamping bracket (11).

3. The coupling device according to claim 2, wherein the mounting section (70, 71, 72, 80, 81) has a detent section (72.2) for engagement with a detent element (92.2) situated on the accessory (61) or the luggage holding unit (60) to produce a detachable detent connection.

4. The coupling device according to claim 3, wherein the mounting section (70, 71, 72, 80, 81) has an insertion rail with two parallel protruding or recessed guide sections (72.1) or with guide sections (72.1) that extend at an acute angle with respect to each other.

5. The coupling device according to claim 4, wherein the accessory (61) or the luggage holding unit (60) has a counterpart mounting section (90) adapted to the mounting section (70, 71, 72, 80).

6. The coupling device according to claim 5, wherein the mounting section (70, 71, 72, 80) and the counterpart mounting section (90) are engageable with each other in a hanging fashion, a sliding fashion, or a plugging fashion and a securing element (22) secures a coupled state of the accessory (61) or the luggage holding unit (60).

7. The coupling device according to claim 6, wherein the mounting section (1) is provided on the handlebar stem (1) or the handlebar clamping bracket (11), on a top, a front, or a bottom with respect to an orientation of the bicycle.

8. The coupling device according to claim 1, wherein the mounting section (70, 71, 72, 80, 81) has a detent section (72.2) for engagement with a detent element (92.2) situated on the accessory (61) or the luggage holding unit (60) to produce a detachable detent connection.

9. The coupling device according to claim 1, wherein the mounting section (70, 71, 72, 80, 81) has an insertion rail with two parallel protruding or recessed guide sections (72.1) or with guide sections (72.1) that extend at an acute angle with respect to each other.

10. The coupling device according to claim 1, wherein the accessory (61) or the luggage holding unit (60) has a counterpart mounting section (90) adapted to the mounting section (70, 71, 72, 80).

11. The coupling device according to claim 10, wherein the mounting section (70, 71, 72, 80) and the counterpart mounting section (90) are engageable with each other in a hanging fashion, a sliding fashion, or a plugging fashion and a securing element (22) secures a coupled state of the accessory (61) or the luggage holding unit (60).

12. The coupling device according to claim 1, wherein the mounting section (1) is provided on the handlebar stem (1) or the handlebar clamping bracket (11), on a top, a front, or a bottom with respect to an orientation of the bicycle.
